(19) United States
(12) Patent Application Publication
(10) Pub. No.: US 2026/0219865 A1
(43) Pub. Date: Jul. 30, 2026

(54) MANAGING DATA LAYER INTEGRATION FOR CONTAINER IMAGES

(71) Applicant: International Business Machines Corporation, Armonk, NY (US)

(72) Inventors: Xiao Ling Chen, Changping District (CN); Yuan Li, Beijing (CN); Si Yu Chen, Beijing (CN); Zhi Li, Haidian (CN)

(21) Appl. No.: 19/039,126

(22) Filed: Jan. 28, 2025

(51) Int. Cl. G06F 8/65

(52) U.S. Cl. CPC G06F 8/65

(57) ABSTRACT

Management of data layer integration for container images includes receiving an integration command and identifying a source repository including at least one reserved patch layer. A system detects the at least one reserved patch layer in the source repository and obtains patch metadata information. The system identifies the at least one identifier in manifest information of each container image of a set of container images. The system determines that the patch metadata information includes a reserved layer attribute. The system obtains the reserved layer content of the at least one reserved patch layer and integrates the reserved layer content with the target data layer.

### BACKGROUND

The disclosure relates to data layer integration and more particularly, to the management of data layer integration.

In container technology, container images function as modular units for software deployment, encapsulating applications along with their dependencies within isolated environments. Each container image includes multiple data layers, with each data layer representing a distinct set of modifications or additions to an underlying file system. This layered architecture allows efficient storage and transfer, enabling swift deployment and scaling of the applications across various environments.

When a container image is created, each data layer of the container image is committed as part of the overall container image, which is then uploaded to a centralized container repository for distribution. The centralized container repository serves as a hub for users to access and deploy the container images. However, when it comes to updating the applications, the users have to upload or download numerous data layers associated with the applications. This process can be time-consuming, resource-intensive, and prone to errors, particularly in dynamic environments where rapid updates are required to maintain application performance and security.

### SUMMARY

In various embodiments of the disclosure, a computer-implemented method for managing data layer integration for container images is described. The computer-implemented method includes receiving an integration command for integrating at least one reserved patch layer with a target data layer. The target data layer is associated with at least one target container image. The computer-implemented method further includes identifying a source repository including the at least one reserved patch layer based on the received integration command. Further, the computer-implemented method includes detecting the at least one reserved patch layer in the identified source repository. The computer-implemented method further includes obtaining patch metadata information of the detected at least one reserved patch layer. The computer-implemented method further includes determining that the obtained patch metadata information includes a reserved layer attribute. The reserved layer attribute indicates that the detected at least one reserved patch layer includes one or more updates to be integrated with the target data layer. The computer-implemented method includes obtaining reserved layer content of the detected at least one reserved patch layer based on the determination that the obtained patch metadata information includes the reserved layer attribute. The computer-implemented method also includes integrating the obtained reserved layer content with the target data layer of the at least one target container image.

In various embodiments of the disclosure, a computer system for managing data layer integration for container images is described. The computer system includes a processor set, one or more computer-readable storage media, and program instructions stored on one or more computer-readable storage media. The program instructions executable by the processor set to cause the processor set to receive an integration command to integrate at least one reserved patch layer with a target data layer. The target data layer is associated with at least one target container image. The program instructions are executable by the processor set to cause the processor set to detect the at least one reserved patch layer in a source repository based on the received integration command. Further, the program instructions executable by the processor set to cause the processor set to obtain patch metadata information of the detected at least one reserved patch layer based on the received integration command. The program instructions executable by the processor set to cause the processor set to determine that the obtained patch metadata information includes a reserved layer attribute. The reserved layer attribute indicates that the detected at least one reserved patch layer includes one or more updates to be integrated with the target data layer. The program instructions executable by the processor set to cause the processor set to detect at least one parent layer of the reserved patch layer in at least one target repository of the at least one target container image. The detection of the at least one parent layer is based on the determination that the obtained patch metadata information includes the reserved layer attribute. Further, the program instructions executable by the processor set to cause the processor set to determine that the detected at least one parent layer is one of a base layer of the at least one reserved patch layer or a non-base layer of the at least one reserved patch layer. Furthermore, the program instructions executable by the processor set to cause the processor set to obtain reserved layer content of the detected at least one reserved patch layer based on the determination that the detected at least one parent layer is the base layer of the at least one reserved patch layer. The program instructions executable by the processor set to cause the processor set to integrate the obtained reserved layer content with the target data layer of the at least one target container image.

In various embodiments of the disclosure, a computer program product for managing data layer integration for container images is described. The computer program product includes one or more computer-readable storage medium and program instructions stored on the one or more computer-readable storage media to perform operations. The operations include receiving an integration command for integrating at least one reserved patch layer with a target data layer. The target data layer is associated with at least one target container image. The operations include identifying a source repository including the at least one reserved patch layer based on the received integration command. Further, the operations include detecting the at least one reserved patch layer in the identified source repository. The operations include obtaining patch metadata information of the detected at least one reserved patch layer. The operations include determining that the obtained patch metadata information includes a reserved layer attribute. The reserved layer attribute indicates that the detected at least one reserved patch layer includes one or more updates to be integrated with the target data layer. The operations include obtaining reserved layer content of the detected at least one reserved patch layer based on the determination that the obtained patch metadata information includes the reserved layer attribute. The operations also include integrating the obtained reserved layer content with the target data layer of the at least one target container image.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for the management of data layer integration for container images, in accordance with an embodiment of the disclosure;

FIG. 2 is a diagram that illustrates a network environment for the management of data layer integration for the container images, in accordance with an embodiment of the disclosure;

FIG. 3A and FIG. 3B are diagrams that illustrate a pictorial depiction of the management of the data layer integration for the container images, in accordance with an embodiment of the disclosure;

FIG. 4 is a diagram that illustrates a system-level architecture of a system for the management of the data layer integration for the container images, in accordance with an embodiment of the disclosure;

FIG. 5 is a diagram that illustrates exemplary operations of the system for the management of the data layer integration for the container images, in accordance with an embodiment of the disclosure;

FIG. 6 is a diagram that illustrates exemplary operations of a layer generation sub-system of the system and a layer integration sub-system of the system for the management of the data layer integration for the container images, in accordance with an embodiment of the disclosure;

FIG. 7 is a diagram that illustrates exemplary operations of the layer integration sub-system for the management of the data layer integration for the container images, in accordance with an embodiment of the disclosure;

FIG. 8 is a diagram that illustrates a first flowchart of an exemplary method for the management of the data layer integration for the container images, in accordance with an embodiment of the disclosure; and

FIG. 9 is a diagram that illustrates a second flowchart of an exemplary method for the management of the data layer integration for the container images, in accordance with an embodiment of the disclosure.

### DETAILED DESCRIPTION

Container technology has transformed software development and deployment, allowing applications to be packaged with their dependencies into isolated environments known as containers. This approach enhances portability, scalability, and consistency across various computing platforms. Thus, containerization has become a cornerstone of agile development practices and continuous delivery, enabling rapid updates and seamless integration into cloud-native architectures. As enterprises increasingly adopt containerization for their applications, the need for efficient management of updates and security patches becomes critical. However, traditional methods of handling these updates can expose organizations to vulnerabilities, highlighting the necessity for innovative solutions that streamline the patching process while maintaining operational integrity.

In the current landscape of the container technology, when an image is committed, contents of its layers are packaged and pushed to a repository. Consequently, when pulling an image, users must download not only specified image layers but also parent layers, leading to inefficient use of bandwidth and time. For enterprise users, the urgency of addressing security vulnerabilities, particularly high-severity Common Vulnerabilities and Exposures (CVEs), is paramount. Organizations have to install the security vulnerabilities across numerous running containers that exploit the same image version, impacting potentially tens, hundreds, or even thousands of containers. The challenge is exacerbated by the fact that it can take 30 days or longer for new image layers containing security fixes to be delivered by product providers.

For example, the latest security update to an application is available in Layer 10 (L10). If there are critical Common Vulnerabilities and Exposures (CVE) fixes that need to be addressed, the CVE fixes may be included in a planned future Layer 11. However, users cannot pull Layer 11 and apply it to their running containers until it is officially released. This waiting period leaves users vulnerable, as they cannot update their containers to include the security patches, and they must continue to rely on the outdated Layer 10. Further, existing solutions allow for the installation of patches on containers running on a single local host. However, they do not address the need for updates across multiple hosts, which is crucial for comprehensive enterprise-level security and operational continuity.

To address these challenges, the proposed system incorporates a new property known as “reserved layer attribute” into metadata of data layers of the container images. This new property enables the seamless installation of patch fixes across various host platforms, enabling organizations to quickly apply updates to exploited containers, regardless of their host locations. By automating the patching process and allowing for rapid deployment, this approach significantly reduces the time to mitigate security vulnerabilities, thereby enhancing the resilience of enterprise-level production environments. Furthermore, the solution operates transparently for both developers and end-users, ensuring that the underlying complexities of image updates do not hinder operational efficiency. The proposed system not only promotes the robustness of enterprise infrastructures but also minimizes exposure to security threats, reinforcing the importance of timely and effective patch management in the modern container ecosystem.

In various embodiments of the disclosure, a computer-implemented method for managing data layer integration for container images is described. The computer-implemented method includes receiving an integration command for integrating at least one reserved patch layer with a target data layer. The target data layer is associated with at least one target container image. The computer-implemented method further includes identifying a source repository including the at least one reserved patch layer based on the received integration command. Further, the computer-implemented method includes detecting the at least one reserved patch layer in the identified source repository. The computer-implemented method further includes obtaining patch metadata information of the detected at least one reserved patch layer. The computer-implemented method further includes determining that the obtained patch metadata information includes a reserved layer attribute. The reserved layer attribute indicates that the detected at least one reserved patch layer includes one or more updates to be integrated with the target data layer. The computer-implemented method includes obtaining reserved layer content of the detected at least one reserved patch layer based on the determination that the obtained patch metadata information includes the reserved layer attribute. The computer-implemented method also includes integrating the obtained reserved layer content with the target data layer of the at least one target container image.

In various embodiments of the disclosure, the computer-implemented method further includes receiving an assignment command for assigning the reserved layer attribute to the at least one reserved patch layer. The computer-implemented method further includes extracting a set of keywords from the received assignment command. Further, the computer-implemented method includes storing the reserved layer attribute in the patch metadata information of the at least one reserved patch layer based on the extracted set of keywords.

In various embodiments of the disclosure, the set of keywords indicates an action to be performed on the at least one reserved patch layer, a container number associated with the at least one reserved patch layer, and the reserved layer attribute.

In various embodiments of the disclosure, the computer-implemented method includes detecting at least one parent layer of the at least one reserved patch layer in at least one target repository of the at least one target container image. The detection of the at least one parent layer is based on the determination that the obtained patch metadata information includes the reserved layer attribute. The at least one parent layer includes parent layer content. Further, the computer-implemented method includes determining that the detected at least one parent layer is one of a base layer of the at least one reserved patch layer or a non-base layer of the at least one reserved patch layer. Further, the computer-implemented method includes obtaining the reserved layer content of the detected at least one reserved patch layer based on the determination that the detected at least one parent layer is the base layer of the at least one reserved patch layer.

In various embodiments of the disclosure, the computer-implemented method includes obtaining parent metadata information of the detected at least one parent layer based on the determination that the detected at least one parent layer is the non-base layer of the at least one reserved patch layer. Further, the computer-implemented method includes determining that the obtained parent metadata information of the detected at least one parent layer one of includes the reserved layer attribute or excludes the reserved layer attribute. Furthermore, the computer-implemented method includes obtaining the reserved layer content of the at least one reserved patch layer based on the determination that the obtained parent metadata information excludes the reserved layer attribute.

In various embodiments of the disclosure, the computer-implemented method includes obtaining parent metadata information of the detected at least one parent layer based on the determination that the detected at least one parent layer is the non-base layer of the at least one reserved patch layer. Further, the computer-implemented method includes determining that the obtained parent metadata information of the detected at least one parent layer one of includes the reserved layer attribute or excludes the reserved layer attribute. Furthermore, the computer-implemented method includes obtaining the reserved layer content of the at least one reserved patch layer based on the determination that the obtained parent metadata information excludes the reserved layer attribute.

In various embodiments of the disclosure, the computer-implemented method includes prompting a user device to select an action from one or more actions to be performed on the at least one reserved patch layer. The user device is prompted based on the determination that the obtained parent metadata information of the detected at least one parent layer includes the reserved layer attribute. The one or more actions include a replace action, a merge action, and an abandon action. Further, the computer-implemented method includes receiving a user input from the user device based on the prompting of the user device. The user input indicates the action from the one or more actions. Furthermore, the computer-implemented method includes performing the action on the reserved patch layer based on the received user input.

In various embodiments of the disclosure, the computer-implemented method includes determining that the received user input indicates the replace action. Further, the computer-implemented method includes removing the detected at least one parent layer from the at least one target repository based on the determination that the received user input indicates the replace action. Furthermore, the computer-implemented method includes storing the at least one reserved patch layer in the at least one target container image based on the removal of the detected at least one parent layer.

In various embodiments of the disclosure, the computer-implemented method includes determining that the received user input indicates the merge action. Further, the computer-implemented method includes obtaining the reserved layer content of the at least one reserved patch layer based on the determination that the received user input indicates the merge action. Furthermore, the computer-implemented method includes integrating the obtained reserved layer content with the parent layer content. The integration of the obtained reserved layer content is within the detected at least one parent layer stored in the at least one target repository. The computer-implemented method includes determining that the detected at least one parent layer includes the reserved layer content, and the parent layer content based on the integration of the obtained reserved layer content with the parent layer content.

In various embodiments of the disclosure, the computer-implemented method includes determining that the received user input indicates the abandon action. Further, the computer-implemented method includes terminating an ongoing synchronization process associated with the integration of the at least one reserved patch layer with the target data layer. The termination of the ongoing synchronization process is based on the determination that the received user input indicates the abandon action.

In various embodiments of the disclosure, a computer system for managing data layer integration for container images is described. The computer system includes a processor set, one or more computer-readable storage media, and program instructions stored on one or more computer-readable storage media. The program instructions executable by the processor set to cause the processor set to receive an integration command to integrate at least one reserved patch layer with a target data layer. The target data layer is associated with at least one target container image. The program instructions are executable by the processor set to cause the processor set to detect the at least one reserved patch layer in a source repository based on the received integration command. Further, the program instructions executable by the processor set to cause the processor set to obtain patch metadata information of the detected at least one reserved patch layer based on the received integration command. The program instructions executable by the processor set to cause the processor set to determine that the obtained patch metadata information includes a reserved layer attribute. The reserved layer attribute indicates that the detected at least one reserved patch layer includes one or more updates to be integrated with the target data layer. The program instructions executable by the processor set to cause the processor set to detect at least one parent layer of the at least one reserved patch layer in at least one target repository of the at least one target container image. The detection of the at least one parent layer is based on the determination that the obtained patch metadata information includes the reserved layer attribute. Further, the program instructions executable by the processor set to cause the processor set to determine that the detected at least one parent layer is one of a base layer of the at least one reserved patch layer or a non-base layer of the at least one reserved patch layer. Furthermore, the program instructions executable by the processor set to cause the processor set to obtain reserved layer content of the detected at least one reserved patch layer based on the determination that the detected at least one parent layer is the base layer of the at least one reserved patch layer. The program instructions executable by the processor set to cause the processor set to integrate the obtained reserved layer content with the target data layer of the at least one target container image.

In various embodiments of the disclosure, the program instructions executable by the processor set to cause the processor set to receive an assignment command to assign the reserved layer attribute to the at least one reserved patch layer. Further, the program instructions executable by the processor set to cause the processor set to extract a set of keywords from the received assignment command. The program instructions executable by the processor set to cause the processor set to store the reserved layer attribute in the patch metadata information of the at least one reserved patch layer based on the extracted set of keywords.

In various embodiments of the disclosure, the set of keywords indicates an action to be performed on the at least one reserved patch layer, a container number associated with the at least one reserved patch layer, and the reserved layer attribute.

In various embodiments of the disclosure, the program instructions executable by the processor set to cause the processor set to obtain parent metadata information of the detected at least one parent layer based on the determination that the detected at least one parent layer is the non-base layer of the at least one reserved patch layer. Further, the program instructions executable by the processor set to cause the processor set to determine that the obtained parent metadata information of the detected at least one parent layer includes the reserved layer attribute. Furthermore, the program instructions executable by the processor set to cause the processor set to prompt a user device to select an action from one or more actions to be performed on the at least one reserved patch layer. The user device is prompted based on the determination that the obtained parent metadata information of the detected at least one parent layer includes the reserved layer attribute. The one or more actions include a replace action, a merge action, and an abandon action. The program instructions executable by the processor set to cause the processor set to receive a user input from the user device when the user device is prompted. The user input indicates the action from the one or more actions. The program instructions executable by the processor set to cause the processor set to perform the action on the at least one reserved patch layer based on the received user input.

In various embodiments of the disclosure, the program instructions executable by the processor set to cause the processor set to determine that the received user input indicates the replace action. Further, the program instructions executable by the processor set to cause the processor set to remove the detected at least one parent layer from the at least one target repository based on the determination that the received user input indicates the replace action. Furthermore, the program instructions executable by the processor set to cause the processor set to store the at least one reserved patch layer in the at least one target container image based on the removal of the detected at least one parent layer.

In various embodiments of the disclosure, the program instructions executable by the processor set to cause the processor set to determine that the received user input indicates the merge action. Further, the program instructions executable by the processor set to cause the processor set to obtain the reserved layer content of the at least one reserved patch layer based on the determination that the received user input indicates the merge action. Furthermore, the program instructions executable by the processor set to integrate the obtained reserved layer content with parent layer content of the detected at least one parent layer. The integration of the obtained reserved layer content is within the detected at least one parent layer stored in the at least one target repository. Further, the program instructions executable by the processor set to determine that the detected at least one parent layer includes the reserved layer content and the parent layer content based on the integration of the obtained reserved layer content with the parent layer content.

In various embodiments of the disclosure, the program instructions executable by the processor set to cause the processor set to determine that the received user input indicates the abandon action. Further, the program instructions executable by the processor set to cause the processor set to terminate an ongoing synchronization process associated with the integration of the at least one reserved patch layer with the target data layer. The termination of the ongoing synchronization process is based on the determination that the received user input indicates the abandon action.

In various embodiments of the disclosure, the reserved layer content is stored on one of a discrete host platform or a single host platform.

In various embodiments of the disclosure, a computer program product for managing data layer integration for container images is described. The computer program product includes one or more computer-readable storage medium and program instructions stored on the one or more computer-readable storage media to perform operations. The operations include receiving an integration command for integrating at least one reserved patch layer with a target data layer. The target data layer is associated with at least one target container image. The operations further include identifying a source repository including the at least one reserved patch layer based on the received integration command. Further, the operations include detecting the at least one reserved patch layer in the identified source repository. The operations further include obtaining patch metadata information of the detected at least one reserved patch layer. The operations further include determining that the obtained patch metadata information includes a reserved layer attribute. The reserved layer attribute indicates that the detected at least one reserved patch layer includes one or more updates to be integrated with the target data layer. The operations include obtaining reserved layer content of the detected at least one reserved patch layer based on the determination that the obtained patch metadata information includes the reserved layer attribute. The operations also include integrating the obtained reserved layer content with the target data layer of the at least one target container image.

In various embodiments of the disclosure, the program instructions stored on the one or more computer-readable storage media perform operations including determining source manifest information associated with the source container image based on the detection of the at least one source data layer. The operations also include generating a target manifest field based on the source manifest information. The target manifest field is associated with target manifest information of the at least one target container image. The target manifest field includes one or more references to the at least one source data layer.

In various embodiments of the disclosure, the program instructions stored on the one or more computer-readable storage media perform operations including detecting an availability of source layer content associated with the at least one source data layer in a source repository. The availability of the source layer content in the source repository is detected based on the source manifest information. Further, the operations include obtaining one or more source attributes associated with the at least one source data layer based on the source manifest information and the detection of the availability of the source layer content. The one or more source attributes correspond to first metadata associated with the at least one source data layer of the source container image. The operations also include generating the target manifest field for the target data layer based on the one or more source attributes. A set of target data layers of the at least one target container image includes the target data layer. The operations also include storing the target manifest field in a target repository.

In various embodiments of the disclosure, the program instructions stored on the one or more computer-readable storage media perform operations including receiving an assignment command for assigning the reserved layer attribute to the at least one reserved patch layer. The computer-operations further include extracting a set of keywords from the received assignment command. Further, the operations include storing the reserved layer attribute in the patch metadata information of the at least one reserved patch layer based on the extracted set of keywords.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or freely propagating electromagnetic waves, electromagnetic waves propagating through a waveguide, light pulses passing through a fiber optic cable, electrical signals communicated through a wire, and/or additional transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

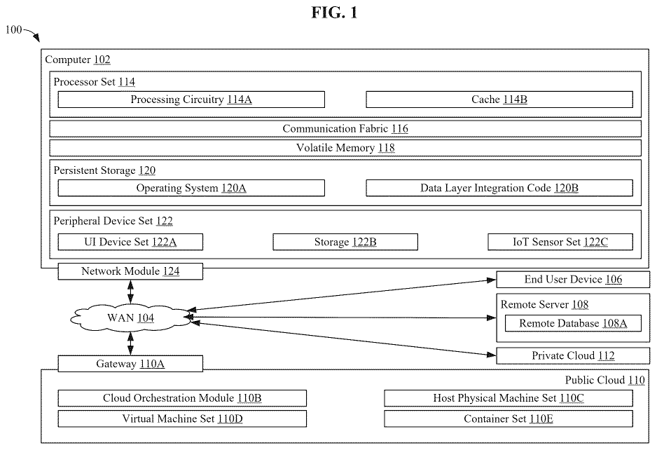

FIG. 1 is a diagram that illustrates a computing environment for the management of data layer integration for container images, in accordance with an embodiment of the disclosure. With reference to FIG. 1, there is shown a computing environment 100 that contains an example of an environment for the execution of at least some of the computer code involved in performing the disclosed methods, such as a data layer integration code 120B. In addition to the data layer integration code 120B, the computing environment 100 includes, for example, a computer 102, a wide area network (WAN) 104, an end user device (EUD) 106, a remote server 108, a public cloud 110, and a private cloud 112. In various embodiments of the disclosure, the computer 102 includes a processor set 114 (including a processing circuitry 114A and a cache 114B), a communication fabric 116, a volatile memory 118, a persistent storage 120 (including an operating system 120A and the data layer integration code 120B (as identified above)), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or wearable computer, a mainframe computer, a quantum computer, or a form of a computer or a mobile device now known or to be developed in the future that is configured to run a program, accessing a network or querying a database, such as the remote database 108A. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B. The program instructions, and associated data, are accessed by the processor set 114 to control and direct the performance of the disclosed methods. In the computing environment 100, at least some of the instructions for performing the disclosed methods may be stored in the dynamic modification of the data layer integration code 120B in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, physical input/output ports, and the like. Further, signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to the computer 102, but alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to the computer 102 and/or directly to the persistent storage 120. The persistent storage 120 may be a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the data layer integration code 120B typically includes at least some of the computer code involved in performing the disclosed methods.

The peripheral device set 122 includes the set of peripheral devices of the computer 102. Data communication connections between the peripheral devices and the components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In various embodiments of the disclosure, the storage 122B may take the form of a quantum computing storage device for storing data in the form of qubits. In various embodiments of the disclosure where the computer 102 is required to have a large amount of storage (for example, where the computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that may be used in Internet of Things applications. For example, a first sensor may be a thermometer and a second sensor may be a motion detector.

The network module 124 is the collection of computer software, hardware, and firmware that allows the computer 102 to communicate with computers through the WAN 104. The network module 124 may include hardware, such as modems or Wi-Fi signal transceivers, software for packetizing and/or de-packetizing data for communication network transmission, and/or web browser software for communicating data over the internet. In various embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods may typically be downloaded to the computer 102 from an external computer or external storage device through a network adapter card or network interface included in the network module 124.

The WAN 104 is any wide area network (for example, the internet) configured to communicate computer data over non-local distances by any technology for communicating computer data, now known or to be developed in the future. In various embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates the computer 102) and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation may typically be communicated from the network module 124 of the computer 102 through the WAN 104 to the EUD 106. In this way, the EUD 106 may display, or otherwise present recommendations to an end user. In various embodiments of the disclosure, the EUD 106 may be a client device, such as a thin client, a heavy client, a mainframe computer, a desktop computer, and so on.

The remote server 108 is any computer system that serves at least some data and/or functionality to the computer 102. The remote server 108 may be controlled and used by the same entity that operates the computer 102. The remote server 108 represents the machines that collect and store helpful and useful data for use by computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows the public cloud 110 to communicate through the WAN 104.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system may utilize resources of that computer, such as connected devices, files and folders, network shares, CPU power, and quantifiable hardware capabilities. However, programs running inside a container may only use the contents of the container and devices assigned to the container, a feature which is known as containerization.

The private cloud 112 may be similar to the public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

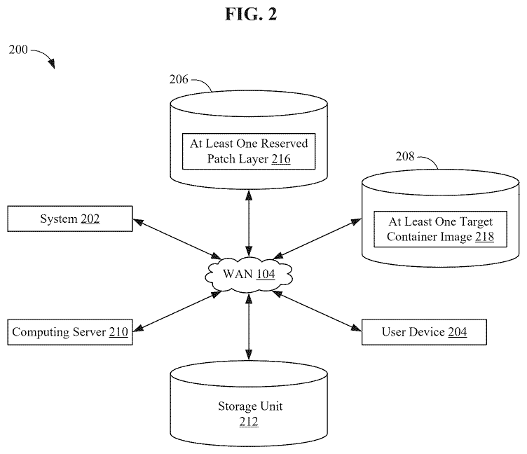

FIG. 2 is a diagram that illustrates a network environment for the management of data layer integration for the container images, in accordance with an embodiment of the disclosure. FIG. 2 is explained in conjunction with elements from FIG. 1. With reference to FIG. 2, there is shown a diagram of a network environment 200. The network environment 200 includes a system 202, a user device 204, a source repository 206, at least one target repository 208, and a computing server 210. Further, the network environment 200 also includes a storage unit 212, such as an internal storage unit and an external storage unit. The network environment 200 further includes a WAN 104 of FIG. 1. In an embodiment of the disclosure, the system 202 is an exemplary embodiment of the computer 102 in FIG. 1.

The system 202 may include suitable logic, circuitry, interfaces, and/or code that is configured for the management of data layer integration for the container images. In an embodiment of the disclosure, the container images are packaged executable files including a set of components to run an application. For example, the set of components may include an application code, a set of libraries, and a set of dependencies associated with the application. Further, the data layers correspond to individual components that are combined to form a container image. Further, each data layer represents a set of changes or additions, allowing for efficient storage, reuse, and management of the application's components.

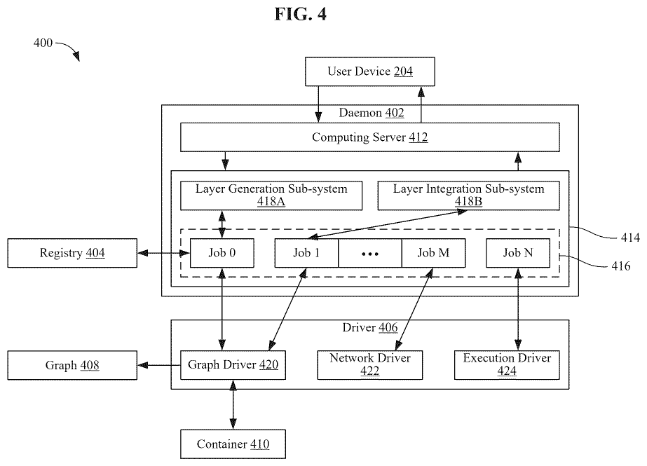

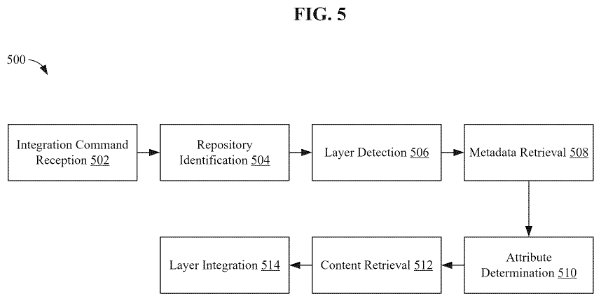

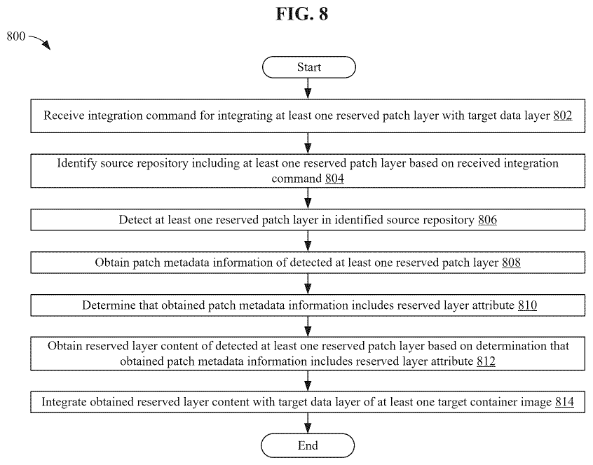

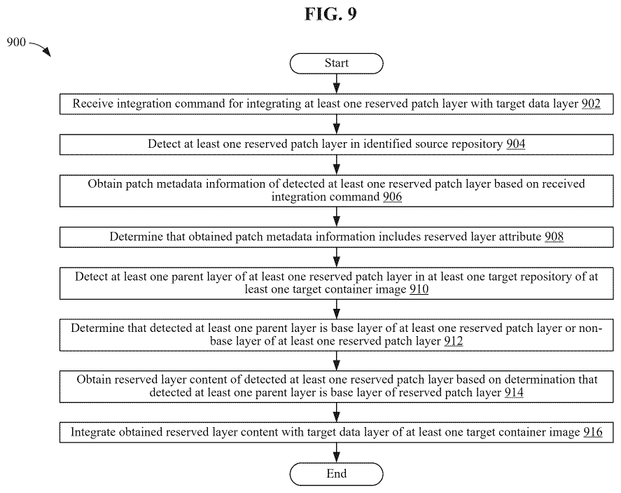

The system 202 may include suitable logic, circuitry, interfaces, and/or code that is configured for the management of data layer integration for the container images. The system 202 is configured to receive an integration command for integrating at least one reserved patch layer 216 (alternatively called at least one reserved patches layer) with a target data layer. In an embodiment of the disclosure, the target data layer is associated with the at least one target container image. In an embodiment of the disclosure, the system 202 receives the integration command from the user device 204. Further, the at least one reserved patch layer 216 corresponds to a data layer designated for updates or modifications within the at least one target container image. In an embodiment of the disclosure, the at least one target container image 218 is stored in the at least one target repository 208. Further, the at least one target container image 218 corresponds to a container image that may receive reserved layer content associated with the at least one reserved patch layer 216. Further, the system 202 is configured to identify the source repository 206 including the at least one reserved patch layer 216 based on the received integration command. Details on the identification of the source repository 206 have been explained with reference to at least FIG. 4, FIG. 5, FIG. 8, and FIG. 9.

Further, the system 202 is configured to detect the at least one reserved patch layer 216 in the identified source repository 206. In an embodiment of the disclosure, the detection of the at least one reserved patch layer 216 in the identified source repository 206 ensures that the correct updates are applied to the target data layer. Furthermore, the system 202 is configured to obtain patch metadata information of the detected at least one reserved patch layer 216. In an embodiment of the disclosure, patch metadata information includes characteristics of the at least one reserved patch layer 216 and the attributes of the at least one reserved patch layer 216. For example, the patch metadata information includes a version of the at least one reserved patch layer 216, the changes or updates associated with the at least one reserved patch layer 216, or attributes indicating how the at least one reserved patch layer 216 may be integrated or applied to the target data layer. Furthermore, the system 202 is configured to determine that the obtained patch metadata information includes a reserved layer attribute. The reserved layer attribute indicates that the detected at least one reserved patch layer 216 includes one or more updates to be integrated with the target data layer. The system 202 is further configured to obtain the reserved layer content of the detected at least one reserved patch layer 216 based on the determination that the obtained patch metadata information includes the reserved layer attribute. The system 202 is also configured to integrate the obtained reserved layer content with the target data layer of the at least one target container image. Details on integrating the obtained reserved layer content with the target data layer of the at least one target container image have been explained with reference to, for example, FIG. 5, FIG. 8, and FIG. 9.

In an embodiment of the disclosure, each of the user device 204, the source repository 206, and the at least one target repository 208 is connected independently to the system 202 using the WAN 104, such as 5G, 6G, and future wireless networks. This individual connectivity enables seamless and efficient data exchange between the system 202 and each of the user device 204, the source repository 206, and the at least one target repository 208, allowing for real-time communication and the timely updating of data. By leveraging advanced wireless technologies such as 5G, 6G, and future networks, the system 202 can accommodate data throughput, ensuring that data integration processes are executed without delay resulting in reliability. This enables the system 202 to handle large volumes of data packets efficiently, support concurrent connections from multiple endpoints, and maintain data integrity during transmission, thereby optimizing the performance of distributed applications and enhancing the overall responsiveness of an architecture of the system 202.

Further, the user device 204 includes suitable logic, circuitry, interfaces, and/or code configured to input and transmit the command to the system 202, for integrating the at least one reserved patch layer 216 with the target data layer. In an embodiment of the disclosure, the target data layer is associated with the at least one target container image. In an embodiment of the disclosure, the user device 204 is associated with a user. The user uses the user device 204 to input and transmit the integration command to the system 202. For example, the user may be a system administrator, a software developer, a cloud service provider, a cybersecurity professional, and the like. Further, the user device 204 ensures efficient communication with the system 202 through connectivity technologies like WAN, thereby supporting timely and secure data exchange. The user device 204 is communicatively coupled with the system 202 via the WAN 104. In an embodiment of the disclosure, the user device 204 is an exemplary embodiment of the EUD 106. Examples of the user device 204 may include, but are not limited to, a computing device, a smartphone, a mainframe machine, a server, a computer workstation, a cellular phone, a mobile phone, a gaming device, a consumer electronic (CE) device, a desktop computer, a laptop, a head-mounted device (HMD), and/or any additional electronic device. In an embodiment of the disclosure, the system 202 is implemented in the computing server 210. In an embodiment of the disclosure, the system 202 is implemented in the user device 204.

In an embodiment of the disclosure, a display screen of the user device 204 may include suitable logic, circuitry, and interfaces configured to receive the command. Further, the display screen provides a user-friendly interface where a user may input the integration command for the integration of the at least one reserved patch layer 216 with the target data layer of the at least one target container image. In an embodiment of the disclosure, the display screen may refer to a display screen of the smartphone, a display screen of the laptop, a display screen of the desktop computer, a display screen of a smart-glass device, a see-through display, a projection-based display, an electro-chromic display, or a transparent display. In an embodiment of the disclosure, the display screen is realized through several known technologies such as, but are not limited to, a Liquid Crystal Display (LCD) display, a Light Emitting Diode (LED) display, a plasma display, or an Organic LED (OLED) display technology, or additional display devices.

In an embodiment of the disclosure, the computing server 210 is implemented as a cloud server and may execute operations through web applications, cloud applications, HTTP requests, repository operations, file transfer, and the like. Further, exemplary implementations of the computing server 210 include, but are not limited to, a database server, a file server, a web server, a media server, an application server, a mainframe server, or a cloud computing server.

In an embodiment of the disclosure, the computing server 210 is implemented as a plurality of distributed cloud-based resources by use of several technologies that are well known to those ordinarily skilled in the art. A person with ordinary skill in the art will understand that the scope of the disclosure may not be limited to the implementation of the computing server 210 and the system 202 as two separate entities. In certain embodiments, the functionalities of the computing server 210 can be incorporated in its entirety or at least partially in the system 202, without a departure from the scope of the disclosure.

In an embodiment of the disclosure, the storage unit 212 is configured to store an organized collection of data. The organized collection of data can be accessed electronically from a computer system (such as the system 202). In an embodiment of the disclosure, the storage unit 212 is communicatively coupled to the user device 204. The storage unit 212 communicatively coupled to the user device 204 is configured to store various types of data related to the integration process. For example, the storage unit 212 securely stores the integration command and the patch metadata information.

In an embodiment of the disclosure, the storage unit 212 is communicatively coupled to the system 202 via the WAN 104. The storage unit 212 communicatively coupled to the system 202 stores data generated during the integration processes. The storage unit 212 enhances the capacity of the system 202 to archive the integration command, the patch metadata information, the reserved layer content, or any combination thereof. By leveraging the storage unit 212, the system 202 may be able to manage larger volumes of data effectively. Further, the storage unit 212 is designed to manage, store, retrieve, and update data efficiently. The structure of the storage unit 212 involves tables, records, and fields that can be managed through various database management systems (DBMS). Examples of the storage unit 212 unit may include, but are not limited to, a relational database, a Non-Structured Query Language (SQL) database, a hierarchical database, a network database, a transactional database, a data warehouse, a distributed database, and a data lake.

In various embodiments of the disclosure, the system 202 is configured to receive the integration command for integrating the at least one reserved patch layer 216 with the target data layer. In an embodiment of the disclosure, the target data layer is associated with the at least one target container image. For example, the integration command includes an image Identification (ID) number of an image including the at least one reserved patch layer 216. Further, the system 202 is configured to identify the source repository 206 including the at least one reserved patch layer 216 based on the received integration command. The identification of the source repository 206 ensures that the correct updates are sourced from an appropriate location, enabling an integration process associated with the target data layer. Furthermore, the system 202 is configured to detect the at least one reserved patch layer 216 in the identified source repository 206. The system 202 is further configured to obtain the patch metadata information of the detected at least one reserved patch layer 216. For example, the patch metadata information includes patch ID: reserved-patch-1, version: 1.0.3, change log: fixed security vulnerabilities and improved performance, dependencies: requires base image version 2.1, and the like.

Further, the system 202 is configured to determine that the obtained patch metadata information includes the reserved layer attribute. In an embodiment of the disclosure, the reserved layer attribute indicates that the detected at least one reserved patch layer 216 includes the one or more updates to be integrated with the target data layer. The system 202 is further configured to obtain the reserved layer content of the detected at least one reserved patch layer 216 based on the determination that the obtained patch metadata information includes the reserved layer attribute. In an embodiment of the disclosure, the reserved layer content includes files of the at least one reserved patch layer 216, configurations of the at least one reserved patch layer 216, or scripts of the at least one reserved patch layer 216 for the integration of the at least one reserved patch layer 216 with the target data layer. Furthermore, the system 202 is configured to integrate the obtained reserved layer content with the target data layer of the at least one target container image.

In operation, the system 202 is configured to receive the integration command for integrating the at least one reserved patch layer 216 with the target data layer. In an embodiment of the disclosure, the target data layer is associated with the at least one target container image. Upon receiving the integration command, which includes the image ID number associated with the at least one reserved patch layer 216 (for example, docker pull <ImageID>), the system 202 identifies that the integration command is a request to pull a specific container image from a designated container registry. The system 202 queries the designated container registry associated with the provided image ID to identify the source repository 206 which includes the specified container image. Once the source repository 206 is identified, the system 202 scans the contents of the source repository 206 to detect the at least one reserved patch layer 216 associated with the image ID. This detection process involves checking the metadata of the container images located in the source repository 206 to confirm the presence of the at least one reserved patch layer 216.

After detecting the at least one reserved patch layer 216, the system 202 obtains the patch metadata information of the at least one reserved patch layer 216. The system 202 then analyzes the obtained patch metadata information to determine if the obtained patch metadata information includes the reserved layer attribute, which indicates that the detected at least one reserved patch layer 216 is intended for integration with the target data layer. If the patch metadata information includes the reserved layer attribute, the system 202 obtains the reserved layer content of the at least one reserved patch layer 216. Further, the system 202 integrates the obtained reserved layer content with the target data layer of the at least one target container image. This integration process updates the at least one target container image with the at least one reserved patch layer 216, ensuring that the application benefits from the latest updates and improvements.

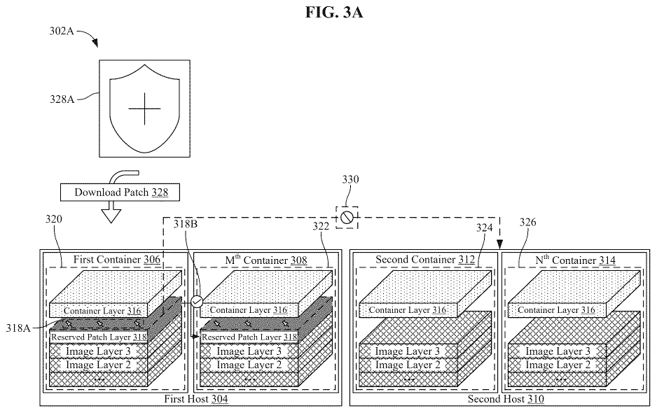

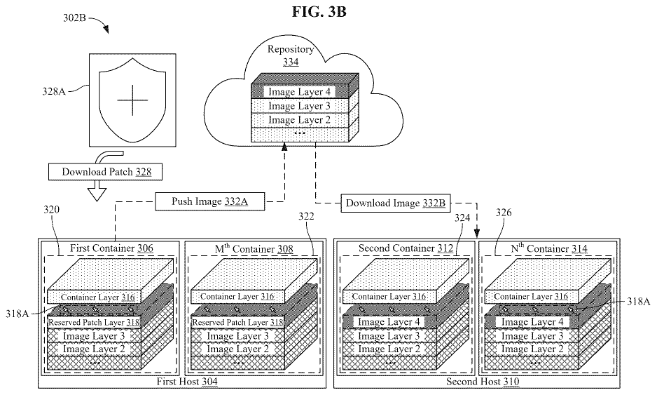

FIG. 3A and FIG. 3B are diagrams that illustrate a pictorial depiction of the management of the data layer integration for the container images, in accordance with an embodiment of the disclosure. FIG. 3A and FIG. 3B are explained in conjunction with elements from FIG. 1, and FIG. 2. For the sake of brevity, FIG. 3A and FIG. 3B have been explained together. With reference to FIG. 3A, a pictorial depiction 302A illustrates the existing container patching mechanisms for applying patches across multiple hosts. The pictorial depiction 302A shows a first host 304 including a first set of containers, such as a first container 306 up to an m^{th} container 308. Further, the pictorial depiction 302A shows a second host 310 including a second set of containers, such as a second container 312 up to n^{th} container 314. Further, each container of the first set of containers and the second set of containers includes a layered architecture. The layered architecture includes a set of image layers/a set of data layers (e.g., image layer 2, image layer 3), and a container layer 316. The image layers represent the base layers of the container image, which are read-only. Further, the container layer 316 represents the writable layer where runtime changes are made. Further, the layered architecture of each first container of the first set of containers includes a reserved patch layer 318. The reserved patch layer 318 is a new layer introduced to integrate the one or more updates to the at least one target layer. As shown in FIG. 3A, the first container 306 includes a first layered architecture 320, the m^{th} container 308 includes a second layered architecture 322, the third container includes a third layered architecture 324, and the n^{th} container 314 includes a fourth layered architecture 326.

In an embodiment of the disclosure, a patch for a security vulnerability (e.g., OpenSSH CVE) is downloaded and installed on the first container 306, at 328. The patch is applied to the reserved patch layer 318, which is a new layer added to the container's metadata. The reserved patch layer 318 includes the patched files (e.g., /bin/ssh, /bin/sshd). In an embodiment of the disclosure, a set of pins 318A in a vicinity of the reserved patch layer 318 indicates that the reserved patch layer 318 includes the patched files. The patch is effective for the first container 306 and is shared with containers on the same host (e.g. m^{th} container 308) because they share the same base image layers and can access the reserved patch layer 318 in a read-only mode. In an embodiment of the disclosure, a right tick 318B symbol indicates that the patch can be shared from the first container 306 to the m^{th} container 308 running on the first host 304. The patch applied to the first container 306 is automatically propagated to the m^{th} container 308 on the same host (e.g., the first host 304) due to a shared reserved patch layer (e.g., reserved patch layer 318 of the first host 304). This ensures that the first set of containers on the same host benefit from the patch without requiring individual updates.

Further, the patch applied to the first container 306 is automatically propagated to containers (e.g., the m^{th} container 308) on the same host (e.g., the first host 304) due to the shared reserved patch layer. This ensures that containers on the same host benefit from the patch without requiring individual updates. The second set of containers on the second host 310 (e.g., the second container 312 up to the n^{th} container 314) do not have access to the reserved patch layer 318 created on the first host 304. As a result, the patch applied to the first container 306 on the first host 304 cannot be propagated to the second set of containers on the second host 310. This limitation is represented by the dashed line with a “no access” symbol 330 between the first host 304 and the second host 310. Further, this limitation is resolved by the system 202 by enabling seamless patch propagation across multiple hosts, as shown in a pictorial depiction 302B.

Furthermore, the pictorial depiction 302B includes the first host 304 and the second host 310 of FIG. 3A. In an embodiment of the disclosure, at 328, a patch for the security vulnerability (e.g., OpenSSH CVE) is downloaded and installed on the first container 306. The patch is applied to the reserved patch layer 318, which is added to the metadata of the first container 306. The reserved patch layer 318 includes patched files (e.g., /bin/ssh, /bin/sshd). The patch is effective for the first container 306 and is shared with containers (e.g., the m^{th} container 308) on the same host (e.g., the first host 304) because the first set of containers share the same base image layers and can access the reserved patch layer 318 in a read-only mode. Further, the updated container image, including the reserved patch layer 318, is pushed to a central repository 334 (e.g., the source repository 206), at 332A. This ensures that the patch is available for hosts to download.

Further, at 332B, the second set of containers on the second host 310 (e.g., the second container 312 up to the n^{th} container 314) downloads the updated container image from the central repository 334, which includes the reserved patch layer 318. The reserved patch layer 318 is added to the one of the data layers/image layers of the second set of containers, ensuring that the patch is applied to the second set of containers on the second host 310. For example, the reserved patch layer 318 is added to image layer 4 of each second container of the second set of containers. In an embodiment of the disclosure, a set of pins 318A in a vicinity of the image layer 4 indicates that the image layer 4 includes the patched files. The reserved patch layer 318 is seamlessly integrated into the container architecture on the second host 310, ensuring that the second set of containers benefits from the patch without requiring manual intervention.

FIG. 4 is a diagram that illustrates a system-level architecture of the system 202 for the management of the data layer integration for the container images, in accordance with an embodiment of the disclosure. FIG. 4 is explained in conjunction with elements from FIG. 1, FIG. 2, FIG. 3A and FIG. 3B. As shown in FIG. 4, a system-level architecture 400 includes the user device 204, a daemon 402, a registry 404, a driver 406, a graph 408, and an image container 410.

In an embodiment of the disclosure, the system 202 receives the integration command using the user device 204 to initiate the integration of the at least one reserved patch layer 216 with the target data layer of the at least one target container image. For example, the integration command is “commit <container-id> reserved patch layer” is used to build Reserved Patches Layer 318 into a new image layer with new metadata property “Reserved Patches Layer” set as Yes or True. The at least one reserved patch layer 216 includes the latest modifications (e.g., the one or more updates) intended for patch management. The daemon 402 is a core service running on a host machine that manages image containers. Further, the daemon 402 includes a set of components, such as a computing server 412 (similar to the computing server 210 of FIG. 2) and a computing engine 414. The computing engine 414 includes a set of jobs 416 (Job 0 to Job N), a layer generation sub-system 418A, and a layer integration sub-system 418B. The computing server 412 acts as the interface for processing the integration command from the user device 204.

In an embodiment of the disclosure, the layer generation sub-system 418A is a component of the system 202. The layer generation sub-system 418A is configured to receive an assignment command that instructs the system 202 to assign the reserved layer attribute to the at least one reserved patch layer 216. Further, the layer generation sub-system 418A extracts a set of keywords from the received command, which are used for defining the context and specifics of the reserved layer attribute. For example, the set of keywords indicates an action (e.g., pulling a container image) to be performed on the at least one reserved patch layer 216, a container number associated with the at least one reserved patch layer 216, and the reserved layer attribute. Further, the layer generation sub-system 418A stores the reserved layer attribute within the patch metadata information of the at least one reserved patch layer 216, using the extracted set of keywords to ensure that the patch metadata information accurately reflects the characteristics and purpose of the at least one reserved patch layer 216. Furthermore, the set of jobs 416 represents tasks or processes managed by the computing engine 414. The set of jobs 416 interacts with the layer integration sub-system 418B to execute one or more tasks associated with the integration process.

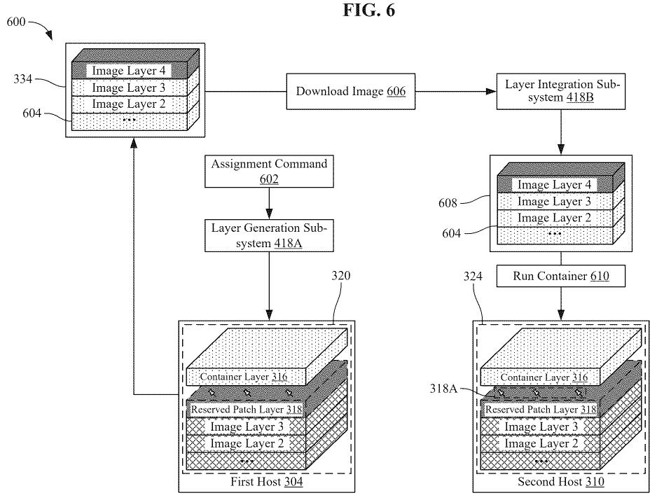

Further, the layer integration sub-system 418B performs a series of coordinated functions aimed at integrating the at least one reserved patch layer 216 with the target data layer of the at least one target container image. The layer integration sub-system 418B receives the integration command that specifies the requirement to merge the at least one reserved patch layer 216 with the target data layer. Upon receiving the integration command, the layer integration sub-system 418B identifies the source repository 206 which includes the at least one reserved patch layer 216. The layer integration sub-system 418B further detects the at least one reserved patch layer 216 within the source repository 206 and obtains the patch metadata information of the at least one reserved patch layer 216. The patch metadata information indicates that the at least one reserved patch layer 216 includes the reserved layer attribute, which signifies that the at least one reserved patch layer 216 includes the one or more updates intended for integration with the target data layer. Further, the layer integration sub-system 418B obtains the reserved layer content from the detected at least one reserved patch layer 216. The layer integration sub-system 418B integrates the reserved layer content with the target data layer of the at least one target container image, ensuring that the one or more updates are effectively applied and the at least one target container image is up to date with the latest patches. Through these operations, the layer integration sub-system 418B enhances the efficiency and security of container management by streamlining the patch integration process. Further, details on the layer generation sub-system 418A and the layer integration sub-system 418B have been explained with reference to at least FIG. 5 and FIG. 6.

In an embodiment of the disclosure, the computing engine 414 is communicatively coupled with the registry 404 (such as the source repository 206 or the at least one target repository 208 of FIG. 2). The registry 404 is a storage location for the container images. The registry 404 interacts with the computing engine 414 to store and retrieve the container images.

Further, the driver 406 is a component that manages low-level operations of the image container 410. The driver 406 includes a graph driver 420, a network driver 422, and an execution driver 424. The network driver 422 manages network configurations for the image container 410, ensuring that the image container 410 is able to communicate with external networks. Further, the execution driver 424 manages the execution environment for the image container 410, managing how the image container 410 runs on the host system. In an embodiment of the disclosure, the graph driver 420 is communicatively coupled with the graph 408 and the image container 410. The graph 408 interacts with the graph driver 420 to manage the storage and retrieval of the data layers, ensuring efficient data handling. Further, the image container 410 stores the updated container image to be deployed and run.

FIG. 5 is a diagram that illustrates exemplary operations of the system 202 for the management of the data layer integration for the container images, in accordance with an embodiment of the disclosure. FIG. 5 is explained in conjunction with elements from FIG. 1, FIG. 2, FIG. 3A, FIG. 3B, and FIG. 4. With reference to FIG. 5, there is shown a block diagram 500 that illustrates exemplary operations from 502 to 514, as described herein. The exemplary operations illustrated in the block diagram 500 start at 502 and are performed by any computing system, apparatus, or device, such as by the computer 102 of FIG. 1 or system 202 of FIG. 2. Although illustrated with discrete blocks, the exemplary operations associated with one or more blocks of the block diagram 500 are divided into additional blocks, combined into fewer blocks, or eliminated, depending on the particular implementation.

Before performing exemplary operations from 502 to 514, the system 202 receives the assignment command for assigning the reserved layer attribute to the at least one reserved patch layer 216. For example, the assignment command may be docker commit <container-id> reserved patch layer, which serves as a directive to assign the reserved layer attribute to a specified patch layer. The assignment command triggers the execution of the layer generation sub-system 418A, which is configured to create a new image layer (e.g., the at least one reserved patch layer 216) that incorporates the reserved patches (e.g., the one or more updates). Further, the system 202 extracts the set of keywords from the received assignment command. For example, the set of keywords indicates an action (e.g., storing the reserved layer attribute in the at least one reserved patch layer 216) to be performed on the at least one reserved patch layer 216, a container number associated with the at least one reserved patch layer 216, and the reserved layer attribute. Furthermore, the system 202 stores the reserved layer attribute in the patch metadata information of the at least one reserved patch layer 216 based on the extracted set of keywords. Storing the reserved layer attribute includes updating the patch metadata information by adding a new property (e.g., the reserved layer attribute), specifically setting “reserved patch layer” to “Yes” or “True”. The patch metadata information not only signifies that the at least one reserved patch layer 216 includes the one or more updates but also allows better organization and retrieval of patch-related information in the future.

At 502, an integration command reception operation is executed. In the integration command reception operation, the system 202 is configured to receive the integration command for integrating the at least one reserved patch layer 216 with the target data layer. In an embodiment of the disclosure, the target data layer is associated with the at least one target container image. In an embodiment of the disclosure, the integration command may be “pull <ImageID>” or “pull <Container ID>”. The integration command instructs the system 202 to retrieve a specific image container from the central repository 334 or the source repository 206. The integration command serves as a trigger for the integration workflow, indicating which image container is to be pulled and integrated with the target data layer. The system 202 parses the integration command to extract the identifiers (e.g., ImageID or Container ID) for integrating the at least one reserved patch layer 216 with the target data layer. In an embodiment of the disclosure, the target data layer is associated with the at least one target container image.

At 504, a repository identification operation is executed. In the repository identification operation, the system 202 is configured to identify the source repository 206 including the at least one reserved patch layer 216 based on the received integration command. The repository identification operation includes querying the central repository 334 or the source repository 206 where the at least one reserved patch layer 216 is stored. The system 202 checks the integration command to determine whether it is pulling an image or a container and then locates the source repository 206 which stores the at least one reserved patch layer 216.

At 506, a layer detection operation is executed. In the layer detection operation, the system 202 is configured to detect the at least one reserved patch layer 216 in the identified source repository 206. The system 202 searches through the content of the source repository 206 to detect the at least one reserved patch layer 216 that matches the criteria (e.g., the container ID) defined in the integration command.

At 508, a metadata retrieval operation is executed. In the metadata retrieval operation, the system 202 is configured to obtain the patch metadata information of the detected at least one reserved patch layer 216. The patch metadata information includes attributes of the detected at least one reserved patch layer 216, versioning of the detected at least one reserved patch layer 216, and the one or more updates associated with the detected at least one reserved patch layer 216. The patch metadata information is used for assessing whether the at least one reserved patch layer 216 is suitable for integration with the target data layer.

At 510, an attribute determination operation is executed. In the attribute determination operation, the system 202 is configured to determine that the obtained patch metadata information includes the reserved layer attribute. In an embodiment of the disclosure, the reserved layer attribute indicates that the detected at least one reserved patch layer 216 includes the one or more updates to be integrated with the target data layer. If the reserved layer attribute is present in the obtained patch metadata information, it indicates that the at least one reserved patch layer 216 is marked for updating the target data layer resulting in the integration process.

At 512, a content retrieval operation is executed. In the content retrieval operation, the system 202 is configured to obtain the reserved layer content of the detected at least one reserved patch layer 216 based on the determination that the obtained patch metadata information includes the reserved layer attribute. The reserved layer content represents the one or more updates and changes that are to be applied to the target data layer. The system 202 accesses the reserved layer content associated with the at least one reserved patch layer 216, ensuring that it has the information for the integration process.

At 514, a layer integration operation is executed. In the layer integration operation, the system 202 is configured to integrate the obtained reserved layer content with the target data layer of the at least one target container image. The layer integration operation includes merging the one or more updates from the at least one reserved patch layer 216 into the target data layer, effectively applying the changes, and ensuring that the at least one target container image is updated with the latest patches. The successful completion of the integration process results in a new version of the at least one target container image that incorporates the updates, enhancing its functionality and security. Throughout the operation from 502 to 514, the system 202 leverages the information provided in the integration command, as well as the patch metadata information associated with the at least one reserved patch layer 216, to ensure a seamless and efficient execution of the layer integration operation. By following the operation, the system 202 ensures that the at least one target container image is updated with the latest patches and security fixes, keeping it up-to-date and secure.

In an embodiment of the disclosure, the layer integration sub-system 418B executes operation 502 to operation 514 for performing the integration process.

In the layer integration operation, the system 202 is configured to detect at least one parent layer of the at least one reserved patch layer 216 in the at least one target repository 208 of the at least one target container image. For example, the system 202 queries the at least one target repository 208 (for e.g., a local container repository or a remote container registry) to detect data layers (e.g., the at least one parent layer) that are related to the at least one reserved patch layer 216. For example, the system 202 detects the data layers that are marked as parent layers, which are foundational layers upon which the at least one reserved patch layer 216 is built. In an embodiment of the present disclosure, the detection of the at least one parent layer is based on the determination that the obtained patch metadata information includes the reserved layer attribute. The at least one parent layer includes parent layer content.

Further, the system 202 is configured to determine that the detected at least one parent layer is a base layer of the at least one reserved patch layer 216. The base layer is a foundational layer that the at least one reserved patch layer 216 builds upon. This determination is made by analyzing the relationships between the data layers, often defined in the metadata. The system 202 determines if the parent layer is the first layer in the hierarchy that the at least one reserved patch layer 216 depends on. Identifying the base layer ensures that the integration process correctly applies the one or more updates from the at least one reserved patch layer 216 without disrupting the underlying structure of the at least one target container image. Furthermore, the system 202 is configured to obtain the reserved layer content of the detected at least one reserved patch layer 216 based on the determination that the detected at least one parent layer is the base layer of the at least one reserved patch layer 216. The system 202 is further configured to integrate the obtained reserved layer content with the target data layer of the at least one target container image.

In an embodiment of the disclosure, the system 202 is configured to determine that the detected at least one parent layer is the non-base layer of the at least one reserved patch layer 216. Determining that the at least one parent layer is the non-base layer ensures that the integration process does not inadvertently overwrite or conflict with the base layer. Thus, the system 202 maintains the integrity of a structure of the at least one target container image. The system 202 is configured to obtain parent metadata information of the detected at least one parent layer based on the determination that the detected at least one parent layer is the non-base layer of the at least one reserved patch layer 216. For example, the parent metadata information includes a version of the at least one parent layer, dependencies of the at least one parent layer, and any associated reserved layer attributes of the at least one parent layer. In an embodiment of the disclosure, the system 202 is configured to determine that the obtained parent metadata information of the detected at least one parent layer excludes the reserved layer attribute. If the obtained parent metadata information excludes the reserved layer attribute, it indicates that the at least one parent layer is not specifically marked for integration with the at least one reserved patch layer 216. Further, the system 202 is configured to obtain the reserved layer content of the at least one reserved patch layer 216 based on the determination that the obtained parent metadata information excludes the reserved layer attribute. The system 202 is further configured to integrate the obtained reserved layer content with the target data layer of the at least one target container image.

In an embodiment of the disclosure, the system 202 is configured to determine that the obtained parent metadata information of the detected at least one parent layer includes the reserved layer attribute. The system 202 is configured to prompt the user device 204 to select an action from one or more actions to be performed on the at least one reserved patch layer 216. For example, the prompt may be a dialog box, a notification, and the like. In an embodiment of the present disclosure, the user device 204 is prompted based on the determination that the obtained parent metadata information of the detected at least one parent layer includes the reserved layer attribute. For example, the one or more actions include a replace action, a merge action, and an abandon action. In an embodiment of the disclosure, the replace action may replace the at least one parent layer with the at least one reserved patch layer 216. Further, the merge action integrates the reserved layer content of the at least one reserved patch layer 216 with the at least one parent layer. The terminate action terminates any ongoing processes related to the integration of the at least one reserved patch layer 216 with the target data layer. The system 202 is configured to receive a user input from the user device 204 based on the prompting of the user device 204. For example, the user input may be provided by the user by pressing a button, selecting an option from a dropdown menu, inputting a command, and the like. In an embodiment of the disclosure, the user input indicates the action from the one or more actions. Further, the system 202 is configured to perform the action on the at least one reserved patch layer 216 based on the received user input.

The system 202 is configured to determine that the received user input indicates the replace action. Further, the system 202 is configured to remove the detected at least one parent layer from the at least one target repository 208 based on the determination that the received user input indicates the replace action. Further, the system 202 is configured to store the at least one reserved patch layer 216 in the at least one target container image based on the removal of the detected at least one parent layer.

In an embodiment of the disclosure, the system 202 is configured to determine that the received user input indicates the merge action. The system 202 is configured to obtain the reserved layer content of the at least one reserved patch layer 216 based on the determination that the received user input indicates the merge action. The reserved layer content is obtained because the reserved layer content is to be combined with the parent layer content, and it is required to have the correct data for a successful merge action. The system 202 is further configured to integrate the obtained reserved layer content with the parent layer content. In an embodiment of the disclosure, the integration of the obtained reserved layer content is within the detected at least one parent layer stored in the at least one target repository 208. The system 202 is configured to determine that the detected at least one parent layer includes the reserved layer content and the parent layer content based on the integration of the obtained reserved layer content with the parent layer content. Determining that the detected at least one parent layer includes the reserved layer content, and the parent layer content ensures that the integration process is successful and that the at least one target container image is now up to date with the latest changes.

Furthermore, the system 202 is configured to determine that the received user input indicates the abandon action. The system 202 is configured to terminate an ongoing synchronization process associated with the integration of the at least one reserved patch layer 216 with the target data layer. In an embodiment of the disclosure, the termination of the ongoing synchronization process is based on the determination that the received user input indicates the abandon action. The termination action ensures that the ongoing integration process is terminated, ensuring that no further changes are made to the target data layer based on the at least one reserved patch layer 216. This helps maintain the integrity of the at least one target container image and prevents any unintended modifications.

In an embodiment of the disclosure, the reserved layer content is stored on a discrete host platform or a single host platform. The reserved layer content stored on the discrete host platform indicates that the reserved layer content is distributed across different servers or machines, such as the first host 304, and the second host 310. This distribution enables the availability of the reserved layer content, as the reserved layer content is not reliant on a single point of failure. For instance, if one host experiences issues, the second host can continue to serve the reserved layer content, ensuring that applications relying on this data remain operational. Additionally, storing the reserved layer content across multiple hosts can improve load balancing, allowing for better performance by distributing requests among several servers. Further, the reserved layer content stored on the single host platform indicates that the data resides on a single server. This setup can simplify management and reduce latency since the data is localized, making it easier to access and manipulate.

FIG. 6 is a diagram that illustrates exemplary operations of the layer generation sub-system 418A of the system 202 and the layer integration sub-system 418B of the system 202 for the management of the data layer integration for the container images, in accordance with an embodiment of the disclosure. FIG. 6 is explained in conjunction with elements from FIG. 1, FIG. 2, FIG. 3A, FIG. 3B, FIG. 4, and FIG. 5.

As shown in a diagram 600 of FIG. 6, the layer generation sub-system 418A of the system 202 receives the assignment command 602 for assigning the reserved layer attribute to the at least one reserved patch layer 216. For example, the assignment command 602 is “commit <container ID> reserved patch layer”. In an embodiment of the disclosure, the layer generation sub-system 418A is configured to create the at least one reserved patch layer 216, which is a data layer that holds the one or more updates to be applied on the at least one target container image. The layer generation sub-system 418A accesses an exploited container and builds the at least one reserved patch layer 216, effectively encapsulating the one or more updates. The term “exploited container” refers to an image container that is altered or modified in a local environment, indicating that the image container has undergone changes to be captured. Further, the at least one reserved patch layer 216 includes a metadata property (e.g., shared layer attribute) that identifies it as the at l east one reserved patch layer 216, explicitly marked as “Yes” or “True”. This metadata is crucial for ensuring that the at least one reserved patch layer 216 is recognized for its intended purpose (e.g., updating the target data layer), enabling better management and deployment of patches in containerized environments.

In an embodiment of the disclosure, the layer generation sub-system 418A extracts the set of keywords from the received assignment command 602. Further, the layer generation sub-system 418A stores the reserved layer attribute in the patch metadata information of the at least one reserved patch layer 216 based on the extracted set of keywords. The at least one reserved patch layer 216 is stored in the first container image 604. After storing the reserved layer attribute in the patch metadata information, the first layered architecture 320 of the first container image 604 (e.g., stored on the first host 304) includes a set of image layers (e.g., image layer 2, image layer 3), the reserve patch layer 318, and the container layer 316. In an embodiment of the disclosure, the reserve patch layer 318 is stored in an image layer 4 of the first container image 604. Further, the first container image 604 is stored in the central repository 334. In an embodiment of the disclosure, the central repository 334 stores one or more attributes of the least one reserve patch layer, such as an image ID: sha256: 8778d7 . . . , a parent layer ID: eff89a . . . , and reserved patch layer: ‘yes’.

Further, the system 202 downloads the first container image 604, at 606. The layer integration sub-system 418B receives the downloaded first container image 604. In an embodiment of the disclosure, the downloaded first container image 604 is represented in a graph 608 showing the first layered architecture 320. At 610, an image container associated with the downloaded first container image 604 is run, such that the at least one reserved patch layer 216 is integrated with the target data layer (e.g., image layer 4) of the second container image running on the second host 310. Upon integrating the at least one reserved patch layer 216 with the target data layer, the third layered architecture 324 of the second container image includes the set of image layers (e.g., image layer 2, image layer 3), the reserve patch layer 318 (e.g., image layer 4), and the container layer 316.

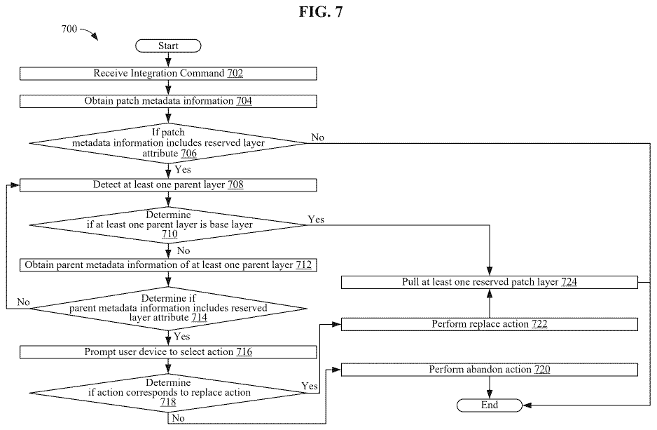

FIG. 7 is a diagram that illustrates exemplary operations of the layer integration sub-system 418B for the management of the data layer integration for the container images, in accordance with an embodiment of the disclosure. FIG. 7 is explained in conjunction with elements from FIG. 1, FIG. 2, FIG. 3A, FIG. 3B, FIG. 4, FIG. 5, and FIG. 6.

As shown in a diagram 700, at 702, the integration command is received. In an embodiment of the disclosure, the layer integration sub-system 418B of the system 202 receives the command and initiates the process of retrieving the at least one reserved patch layer 216 from the remote repository. For example, the integration command may be docker pull <Image ID>. In an embodiment of the disclosure, the layer integration sub-system 418B of the system 202 downloads reserved layer content associated with the at least one reserved patch layer 216. Once the reserved layer content is downloaded, the layer integration sub-system 418B of the system 202 uncompresses the downloaded reserved layer content to prepare it for further processing. The details of the integration command have been explained with reference to at least FIG. 5.

At 704, the patch metadata information of the at least one reserved layer (e.g., image layer 4) is obtained. In an embodiment of the disclosure, the layer integration sub-system 418B of the system 202 obtains the patch metadata information of the at least one reserved layer. The details on obtaining the patch metadata information have been explained with reference to at least FIG. 5, FIG. 8, and FIG. 9.

At 706, it is determined if the obtained patch metadata information includes the reserved layer attribute. In an embodiment of the disclosure, the layer integration sub-system 418B of the system 202 determines if the obtained patch metadata information includes the reserved layer attribute. The reserved layer attribute indicates that the detected at least one reserved patch layer 216 includes one or more updates to be integrated with the target data layer. If it is determined that the obtained patch metadata information includes the reserved layer attribute, the operation moves to 708. Further, if it is determined that the obtained patch metadata information excludes the reserved layer attribute, the operation ends. The details on determining if the obtained patch metadata information includes the reserved layer attribute have been explained with reference to at least FIG. 5, FIG. 8, and FIG. 9.

At 708, the at least one parent layer of the at least one target layer is detected. In an embodiment of the disclosure, the layer integration sub-system 418B of the system 202 detects the at least one parent layer of the at least one target layer. The details on the detection of the at least one parent layer of the at least one target layer have been explained with reference to at least FIG. 5 and FIG. 9.

At 710, it is determined if the detected at least one parent layer is the base layer of the at least one reserved patch layer 216. In an embodiment of the disclosure, the layer integration sub-system 418B of the system 202 determines if the detected at least one parent layer is the base layer of the at least one reserved patch layer 216. If the detected at least one parent layer is the non-base layer of the at least one reserved patch layer 216, the operation moves to 712. Further, if the detected at least one parent layer is the base layer of the at least one reserved patch layer 216, the operation moves to 724. The details on determining if the detected at least one parent layer is the base layer of the at least one reserved patch layer 216 have been explained with reference to at least FIG. 5 and FIG. 9.

At 712, the parent metadata information of the detected at least one parent layer is obtained. In an embodiment of the disclosure, the layer integration sub-system 418B of the system 202 obtains the parent metadata information of the detected at least one parent layer based on the determination that the detected at least one parent layer is the non-base layer of the at least one reserved patch layer 216. The details on obtaining the parent metadata information of the detected at least one parent layer have been explained with reference to at least FIG. 5.

At 714, it is determined if the obtained parent metadata information of the detected at least one parent layer includes the reserved layer attribute. In an embodiment of the disclosure, the layer integration sub-system 418B of the system 202 determines if the obtained parent metadata information of the detected at least one parent layer includes the reserved layer attribute. If the obtained parent metadata information of the detected at least one parent layer excludes the reserved layer attribute, the operation moves to 708. Further, if the obtained parent metadata information of the detected at least one parent layer includes the reserved layer attribute, the operation moves to 716. The details on determining that the obtained parent metadata information of the detected at least one parent layer includes the reserved layer attribute have been explained with reference to at least FIG. 5.

At 716, the user device 204 is prompted to select an action from the one or more actions to be performed on the at least one reserved patch layer 216. In an embodiment of the disclosure, the layer integration sub-system 418B of the system 202 prompts the user device 204 to select the action from the one or more actions to be performed on the at least one reserved patch layer 216. For example, the one or more actions include the replace action and the merge action. The details on prompting the user device 204 to select the action from the one or more actions have been explained with reference to at least FIG. 5.

At 718, it is determined if the action corresponds to the replace action. In an embodiment of the disclosure, the layer integration sub-system 418B of the system 202 determines if the action corresponds to the replace action. If the action does not correspond to the replace action, 720 is performed. Further, if the action corresponds to the replace action, 722 is performed.

At 720, the abandon action is performed. In an embodiment of the disclosure, the layer integration sub-system 418B of the system 202 performs the abandon action. The details of the abandon action have been explained with reference to at least FIG. 5.

At 722, the replace action is performed. In an embodiment of the disclosure, the layer integration sub-system 418B of the system 202 performs the replace action. The details of the replace action have been explained with reference to at least FIG. 5.

At 724, the at least one reserved patch layer 216 is pulled on a local environment. In an embodiment of the disclosure, the layer synchronization sub-system 426 of the system 202 pulls the at least one reserved patch layer 216 on the local environment. In an embodiment of the disclosure, 724 ensures that the complete image container, including data layers, is available for use in the local environment. Further, the at least one reserved patch layer 216 is integrated with the target data layer of the at least one target container image.

FIG. 8 is a diagram that illustrates a first flowchart of an exemplary method for the management of the data layer integration for container images, in accordance with an embodiment of the disclosure. FIG. 8 is explained in conjunction with elements from FIG. 1, FIG. 2, FIG. 3A, FIG. 3B, FIG. 4, FIG. 5, FIG. 6, and FIG. 7. The operations of the exemplary computer-implemented method are executed by any computing system, for example, by the computer 102 of FIG. 1 or the system 202 of FIG. 2. The operations of a first flowchart 800 may start at 802.

At 802, an integration command for integrating at least one reserved patch layer 216 with a target data layer is received. In an embodiment of the disclosure, the target data layer is associated with at least one target container image. In an embodiment of the disclosure, the system 202 is configured to receive the integration command for integrating the at least one reserved patch layer 216 with the target data layer. In an embodiment of the disclosure, the target data layer is associated with the at least one target container image. In an embodiment of the disclosure, the at least one target container image is a destination container image that may receive one or more updates from at least one reserved patch layer 216. Further, the at least one reserved patch layer 216 corresponds to one or more individual data layers that include the one or more updates or functionality to be synchronized with the at least one target data layer. Details about the reception of the command are provided, for example, in FIG. 2, FIG. 5, and FIG. 9.

At 804, a source repository 206 including the at least one reserved patch layer 216 is identified based on the received integration command. In an embodiment of the disclosure, the system 202 is configured to identify the source repository 206 including the at least one reserved patch layer 216 based on the received integration command. The source repository 206 may be a local storage location or a remote server where the at least one reserved patch layer 216 is stored. Details about the identification of the source repository 206 are provided, for example, in FIG. 2 and FIG. 5.

At 806, the at least one reserved patch layer 216 is detected in the identified source repository 206. In an embodiment of the disclosure, the system 202 is configured to detect the at least one reserved patch layer 216 in the identified source repository 206. Details about identification of the at least one identifier are provided, for example, in FIG. 2, FIG. 5, and FIG. 9.

At 808, patch metadata information of the detected at least one reserved patch layer 216 is obtained. In an embodiment of the disclosure, the system 202 is configured to obtain the patch metadata information of the detected at least one reserved patch layer 216. In an embodiment of the present disclosure, the patch metadata information discloses details about the at least one reserved patch layer 216, such as a version of the at least one reserved patch layer 216, a size of the at least one reserved patch layer 216, one or more dependencies of the at least one reserved patch layer 216, and the like. Details on obtaining the patch metadata information are provided, for example, in FIG. 2, FIG. 5, and FIG. 9.

At 810, it is determined that the obtained patch metadata information includes a reserved layer attribute. In an embodiment of the disclosure, the system 202 is configured to determine that the obtained patch metadata information includes the reserved layer attribute. In an embodiment of the disclosure, the reserved layer attribute indicates that the detected at least one reserved patch layer 216 includes one or more updates to be integrated with the target data layer. Details on determining that the obtained patch metadata information includes the reserved layer attribute are provided, for example, in FIG. 2, FIG. 5, and FIG. 9.

At 812, reserved layer content of the detected at least one reserved patch layer 216 is obtained based on the determination that the obtained patch metadata information includes the reserved layer attribute. In an embodiment of the disclosure, the system 202 is configured to obtain the reserved layer content of the detected at least one reserved patch layer 216 based on the determination that the obtained patch metadata information includes the reserved layer attribute. For example, the reserved layer content may include files of the detected at least one reserved patch layer 216, configurations of the detected at least one reserved patch layer 216, or components of the detected at least one reserved patch layer 216 that makes up the detected at least one reserved patch layer 216. Details about obtaining the reserved layer content are provided, for example, in FIG. 2, FIG. 5, and FIG. 9.

At 814, the obtained reserved layer content is integrated with the target data layer of the at least one target container image. In an embodiment of the disclosure, the system 202 is configured to integrate the obtained reserved layer content with the target data layer of the at least one target container image. This integration process ensures that the one or more updates or modifications contained in the at least one reserved patch layer 216 are seamlessly applied to the target data layer effectively updating the at least one target container image with the one or more updates. Details about the integration of the obtained reserved layer content with the target data layer of the at least one target container image are provided, for example, in FIG. 2, FIG. 5, and FIG. 9.

While the above operation of the system 202 shown in FIG. 8 is described in a particular sequence, the operation of the system 202 may occur in variations to the sequence in accordance with various embodiments of the disclosure. Further, details related to the operation of FIG. 8, which are already covered in the description related to FIG. 1 to FIG. 7 are not discussed again in detail here for the sake of brevity.

FIG. 9 is a diagram that illustrates the flowchart of an exemplary method for the management of the data layer integration for the container images, in accordance with an embodiment of the disclosure. FIG. 9 is explained in conjunction with elements from FIG. 1, FIG. 2, FIG. 3A, FIG. 3B, FIG. 4, FIG. 5, FIG. 6, FIG. 7, and FIG. 8. The operations of the exemplary computer-implemented method are executed by any computing system, for example, by the computer 102 of FIG. 1 or the system 202 of FIG. 2. The operations of a second flowchart 900 may start at 902.

Before performing exemplary operations from 902 to 916, an assignment command is received for assigning a reserved layer attribute to at least one reserved patch layer 216. In an embodiment of the present disclosure, the layer generation sub-system 418A is configured to receive the assignment command that instructs the system 202 to assign the reserved layer attribute to the at least one reserved patch layer. For example, the assignment command may be docker commit <container-id> reserved patch layer, which serves as a directive to assign the reserved layer attribute to the specified patch layer. Further, the set of keywords is extracted from the received assignment command. For example, the set of keywords indicates an action (e.g., commit <container-id> reserved patch layer) to be performed on the at least one reserved patch layer 216, a container number associated with the at least one reserved patch layer 216, and the reserved layer attribute. Furthermore, the reserved layer attribute is stored in the patch metadata information of the at least one reserved patch layer 216 based on the extracted set of keywords. Storing the reserved layer attribute includes updating the patch metadata information by adding a new property, specifically setting “reserved patch layer” to “Yes” or “True”.

At 902, an integration command for integrating at least one reserved patch layer 216 with a target data layer is received. In an embodiment of the disclosure, the target data layer is associated with at least one target container image. In an embodiment of the disclosure, the system 202 is configured to receive the integration command for integrating the at least one reserved patch layer 216 with the target data layer. In an embodiment of the disclosure, the target data layer is associated with the at least one target container image. In an embodiment of the disclosure, the at least one target container image is a destination container image that may receive the at least one reserved patch layer 216. Further, the at least one reserved patch layer 216 corresponds to one or more individual data layers that include specific data or functionality to be synchronized with the at least one target data layer. Details about the reception of the command are provided, for example, in FIG. 2, FIG. 5, and FIG. 8.

In an embodiment of the disclosure, the source repository 206 including the at least one reserved patch layer 216 is identified based on the received integration command. The source repository 206 may be a local storage location or a remote server where the at least one reserved patch layer 216 is stored.

At 904, the at least one reserved patch layer 216 is detected in the identified source repository 206. In an embodiment of the disclosure, the system 202 is configured to detect the at least one reserved patch layer 216 in the identified source repository 206. Details about identification of the at least one identifier are provided, for example, in FIG. 2, FIG. 5, and FIG. 8.

At 906, patch metadata information of the detected at least one reserved patch layer 216 is obtained based on the received integration command. In an embodiment of the disclosure, the system 202 is configured to obtain the patch metadata information of the detected at least one reserved patch layer 216 based on the received integration command. In an embodiment of the present disclosure, the patch metadata information discloses details about the at least one reserved patch layer 216, such as a version of the at least one reserved patch layer 216, a size of the at least one reserved patch layer 216, one or more dependencies of the at least one reserved patch layer 216, and the like. Details on obtaining the patch metadata information are provided, for example, in FIG. 2, FIG. 5, and FIG. 8.

At 908, it is determined that the obtained patch metadata information includes a reserved layer attribute. In an embodiment of the disclosure, the system 202 is configured to determine that the obtained patch metadata information includes the reserved layer attribute. In an embodiment of the disclosure, the reserved layer attribute indicates that the detected at least one reserved patch layer 216 includes one or more updates to be integrated with the target data layer. Details on determining that the obtained patch metadata information includes the reserved layer attribute are provided, for example, in FIG. 2, FIG. 5, and FIG. 8.

At 910, at least one parent layer of the at least one reserved patch layer 216 is detected in at least one target repository 208 of the at least one target container image. In an embodiment of the disclosure, the system 202 is configured to detect the at least one parent layer of the at least one reserved patch layer 216 in the at least one target repository 208 of the at least one target container image. In an embodiment of the present disclosure, the at least one parent layer is a data layer upon which the at least one reserved patch layer 216 is built. The detection of the at least one parent layer is based on the determination that the obtained patch metadata information includes the reserved layer attribute. Details about detecting the at least one parent layer of the at least one reserved patch layer 216 in the at least one target repository 208 are provided, for example, in FIG. 5.

At 912, it is determined that the detected at least one parent layer is a base layer of the at least one reserved patch layer 216 or a non-base layer of the at least one reserved patch layer 216. In an embodiment of the disclosure, the system 202 is configured to determine that the detected at least one parent layer is the base layer of the at least one reserved patch layer 216 or the non-base layer of the at least one reserved patch layer 216. In an embodiment of the disclosure, the base layer is the foundational layer in the image hierarchy, including a core operating system or application files. Details about the determination that the detected at least one parent layer is the base layer of the reserved patch layer are provided, for example, in FIG. 5.

At 914, the reserved layer content of the detected at least one reserved patch layer 216 is obtained based on the determination that the detected at least one parent layer is the base layer of the at least one reserved patch layer 216. In an embodiment of the disclosure, the system 202 is configured to obtain the reserved layer content of the detected at least one reserved patch layer 216 based on the determination that the detected at least one parent layer is the base layer of the reserved patch layer. For example, the reserved layer content may include files of the detected at least one reserved patch layer 216, configurations of the detected at least one reserved patch layer 216, or components of the detected at least one reserved patch layer 216 that makes up the detected at least one reserved patch layer 216. Details about obtaining the reserved layer content are provided, for example, in FIG. 5.

At 916, the obtained reserved layer content is integrated with the target data layer of the at least one target container image. In an embodiment of the disclosure, the system 202 is configured to integrate the obtained reserved layer content with the target data layer of the at least one target container image. This integration process ensures that the one or more updates or modifications included in the at least one reserved patch layer 216 are seamlessly applied to the target data layer effectively updating the at least one target container image with the one or more updates. Details about the integration of the obtained reserved layer content with the target data layer of the at least one target container image are provided, for example, in FIG. 2, FIG. 5, and FIG. 8.

While the above operation of the system 202 shown in FIG. 9 is described in a particular sequence, the operation may occur in variations to the sequence in accordance with various embodiments of the disclosure. Further, details related to the operation of FIG. 9, which is already covered in the description related to FIG. 1 to FIG. 8 are not discussed again in detail here for the sake of brevity.

The system 202 presents multiple advantages. For example, by storing the reserved layer attribute in the patch metadata information of the at least one reserved patch layer 216, the system enables the utilization of product capabilities, allowing for the seamless installation of patch fixes across various host platforms. This capability promotes the robustness of enterprise-level production environments, enabling organizations to address security vulnerabilities swiftly and effectively. Further, the proposed system allows users to execute the integration process for multiple target container images with a single integration command. This streamlined approach not only saves time but also reduces the computational overhead associated with managing multiple patch installations. As a result, memory usage is optimized, as the system 202 can handle updates more efficiently without the need for redundant processes. Furthermore, the automation of patch installations minimizes the manual intervention from developers and users, leading to improved processing efficiency and reduced risk of human error.

Additionally, the system 202 performs rapid installation of patches or new features on exploited containers across different hosts. By ensuring that both developers and users can maintain and upgrade the entire environment without the need for frequent patch installations, the system 202 significantly enhances operational efficiency. This capability is beneficial in large-scale environments where managing numerous containers can be resource intensive. The integration process is transparent to both developers and end users, meaning that they can focus on their core tasks without being burdened by the complexities of patch management.

Further, the compatibility of the system 202 with existing container tools ensures that organizations can leverage their current infrastructure without the need for extensive modifications. This compatibility not only preserves existing investments in technology but also enhances the overall resilience of the system 202 by allowing for quick adaptations to new updates and features.

By allowing a single command to execute the integration process for multiple target container images, the system 202 reduces the need for redundant processing across various containers. This efficiency minimizes CPU cycles and memory usage, allowing hardware resources to be allocated more effectively. As a result, organizations can achieve better performance from their existing hardware infrastructure, reducing the need for additional investments in processing power or memory.

In various embodiments of the disclosure, a computer program product for managing data layer integration for container images is described. The computer program product includes one or more computer-readable storage medium and program instructions stored on the one or more computer-readable storage media to perform operations. The operations include receiving an integration command for integrating at least one reserved patch layer with a target data layer. The target data layer is associated with at least one target container image. The operations include identifying a source repository including the at least one reserved patch layer based on the received integration command. Further, the operations include detecting the at least one reserved patch layer in the identified source repository. The operations include obtaining patch metadata information of the detected at least one reserved patch layer. The operations include determining that the obtained patch metadata information includes a reserved layer attribute. The reserved layer attribute indicates that the detected at least one reserved patch layer includes one or more updates to be integrated with the target data layer. The operations include obtaining reserved layer content of the detected at least one reserved patch layer based on the determination that the obtained patch metadata information includes the reserved layer attribute. The operations also include integrating the obtained reserved layer content with the target data layer of the at least one target container image.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer, an integration command for integrating at least one reserved patch layer with a target data layer, wherein the target data layer is associated with at least one target container image;
identifying, by the computer, a source repository comprising the at least one reserved patch layer based on the received integration command;
detecting, by the computer, the at least one reserved patch layer in the identified source repository;
obtaining, by the computer, patch metadata information of the detected at least one reserved patch layer;
determining, by the computer, that the obtained patch metadata information comprises a reserved layer attribute, wherein the reserved layer attribute indicates that the detected at least one reserved patch layer comprises one or more updates to be integrated with the target data layer;
obtaining, by the computer, reserved layer content of the detected at least one reserved patch layer based on the determination that the obtained patch metadata information comprises the reserved layer attribute; and
integrating, by the computer, the obtained reserved layer content with the target data layer of the at least one target container image.

2. The computer-implemented method of claim 1, further comprising:
receiving, by the computer, an assignment command for assigning the reserved layer attribute to the at least one reserved patch layer;
extracting, by the computer, a set of keywords from the received assignment command; and
storing, by the computer, the reserved layer attribute in the patch metadata information of the at least one reserved patch layer based on the extracted set of keywords.

3. The computer-implemented method of claim 2, wherein the set of keywords indicates an action to be performed on the at least one reserved patch layer, a container number associated with the at least one reserved patch layer, and the reserved layer attribute.

4. The computer-implemented method of claim 1, further comprising:
detecting, by the computer, at least one parent layer of the at least one reserved patch layer in at least one target repository of the at least one target container image, wherein the detection of the at least one parent layer is based on the determination that the obtained patch metadata information includes the reserved layer attribute, and wherein the at least one parent layer comprises parent layer content;
determining, by the computer, that the detected at least one parent layer is one of a base layer of the at least one reserved patch layer or a non-base layer of the at least one reserved patch layer; and
obtaining, by the computer, the reserved layer content of the detected at least one reserved patch layer based on the determination that the detected at least one parent layer is the base layer of the at least one reserved patch layer.

5. The computer-implemented method of claim 4, further comprising:
obtaining, by the computer, parent metadata information of the detected at least one parent layer based on the determination that the detected at least one parent layer is the non-base layer of the at least one reserved patch layer;
determining, by the computer, that the obtained parent metadata information of the detected at least one parent layer one of includes the reserved layer attribute or excludes the reserved layer attribute; and
obtaining, by the computer, the reserved layer content of the at least one reserved patch layer based on the determination that the obtained parent metadata information excludes the reserved layer attribute.

6. The computer-implemented method of claim 5, further comprising:
prompting, by the computer, a user device to select an action from one or more actions to be performed on the at least one reserved patch layer, wherein the user device is prompted based on the determination that the obtained parent metadata information of the detected at least one parent layer includes the reserved layer attribute, and wherein the one or more actions comprise a replace action, a merge action, and an abandon action;
receiving, by the computer, a user input from the user device based on the prompting of the user device, wherein the user input indicates the action from the one or more actions; and
performing, by the computer, the action on the at least one reserved patch layer based on the received user input.

7. The computer-implemented method of claim 6, further comprising:
determining, by the computer, that the received user input indicates the replace action; and
removing, by the computer, the detected at least one parent layer from the at least one target repository based on the determination that the received user input indicates the replace action; and
storing, by the computer, the at least one reserved patch layer in the at least one target container image based on the removal of the detected at least one parent layer.

8. The computer-implemented method of claim 6, further comprising:
determining, by the computer, that the received user input indicates the merge action;
obtaining, by the computer, the reserved layer content of the at least one reserved patch layer based on the determination that the received user input indicates the merge action;
integrating, by the computer, the obtained reserved layer content with the parent layer content, wherein the integration of the obtained reserved layer content is within the detected at least one parent layer stored in the at least one target repository; and
determining, by the computer, that the detected at least one parent layer comprises the reserved layer content and the parent layer content based on the integration of the obtained reserved layer content with the parent layer content.

9. The computer-implemented method of claim 6, further comprising:
determining, by the computer, that the received user input indicates the abandon action; and
terminating, by the computer, an ongoing synchronization process associated with the integration of the at least one reserved patch layer with the target data layer, wherein the termination of the ongoing synchronization process is based on the determination that the received user input indicates the abandon action.

10. The computer-implemented method of claim 6, wherein the reserved layer content is stored on one of a discrete host platform or a single host platform.

11. A computer system, comprising:
a processor set;
one or more computer-readable storage media; and
program instructions stored on the one or more computer-readable storage media, the program instructions executable by the processor set to cause the processor set to:
receive an integration command to integrate at least one reserved patch layer with a target data layer, wherein the target data layer is associated with at least one target container image;
detect the at least one reserved patch layer in a source repository based on the received integration command;
obtain patch metadata information of the detected at least one reserved patch layer based on the received integration command;
determine that the obtained patch metadata information comprises a reserved layer attribute, wherein the reserved layer attribute indicates that the detected at least one reserved patch layer comprises one or more updates to be integrated with the target data layer;
detect at least one parent layer of the at least one reserved patch layer in at least one target repository of the at least one target container image, wherein the detection of the at least one parent layer is based on the determination that the obtained patch metadata information includes the reserved layer attribute;
determine that the detected at least one parent layer is one of a base layer of the at least one reserved patch layer or a non-base layer of the at least one reserved patch layer;
obtain reserved layer content of the detected at least one reserved patch layer based on the determination that the detected at least one parent layer is the base layer of the at least one reserved patch layer; and
integrate the obtained reserved layer content with the target data layer of the at least one target container image.

12. The computer system of claim 11, wherein the program instructions further cause the processor set to:
receive an assignment command to assign the reserved layer attribute to the at least one reserved patch layer;
extract a set of keywords from the received assignment command; and
store the reserved layer attribute in the patch metadata information of the at least one reserved patch layer based on the extracted set of keywords.

13. The computer system of claim 12, wherein the set of keywords indicates an action to be performed on the at least one reserved patch layer, a container number associated with the at least one reserved patch layer, and the reserved layer attribute.

14. The computer system of claim 11, wherein the program instructions further cause the processor set to:
obtain parent metadata information of the detected at least one parent layer based on the determination that the detected at least one parent layer is the non-base layer of the at least one reserved patch layer;
determine that the obtained parent metadata information of the detected at least one parent layer includes the reserved layer attribute;
prompt a user device to select an action from one or more actions to be performed on the at least one reserved patch layer, wherein the user device is prompted based on the determination that the obtained parent metadata information of the detected at least one parent layer includes the reserved layer attribute, and wherein the one or more actions comprise a replace action, a merge action, and an abandon action;
receive a user input from the user device when the user device is prompted, wherein the user input indicates the action from the one or more actions; and
perform the action on the at least one reserved patch layer based on the received user input.

15. The computer system of claim 14, wherein the program instructions further cause the processor set to:
determine that the received user input indicates the replace action; and
remove the detected at least one parent layer from the at least one target repository based on the determination that the received user input indicates the replace action; and
store the at least one reserved patch layer in the at least one target container image based on the removal of the detected at least one parent layer.

16. The computer system of claim 14, wherein the program instructions further cause the processor set to:
determine that the received user input indicates the merge action;
obtain the reserved layer content of the at least one reserved patch layer based on the determination that the received user input indicates the merge action;
integrate the obtained reserved layer content with parent layer content of the detected at least one parent layer, wherein the integration of the obtained reserved layer content is within the detected at least one parent layer stored in the at least one target repository; and
determine that the detected at least one parent layer comprises the reserved layer content and the parent layer content based on the integration of the obtained reserved layer content with the parent layer content.

17. The computer system of claim 14, wherein the program instructions further cause the processor set to:
determine that the received user input indicates the abandon action; and
terminate an ongoing synchronization process associated with the integration of the at least one reserved patch layer with the target data layer, wherein the termination of the ongoing synchronization process is based on the determination that the received user input indicates the abandon action.

18. The computer system of claim 11, wherein the reserved layer content is stored on one of a discrete host platform or a single host platform.

19. A computer program product for integrating at least one reserved patch layer with a target data layer, the computer program product comprising:
one or more computer-readable storage media; and
program instructions stored on the one or more computer-readable storage media to perform operations comprising:
receiving an integration command for integrating the at least one reserved patch layer with the target data layer of at least one target container image, wherein the target data layer is associated with the at least one target container image;
identifying a source repository comprising the at least one reserved patch layer based on the received integration command;
detecting the at least one reserved patch layer in the identified source repository;
obtaining patch metadata information of the detected at least one reserved patch layer;
determining that the obtained patch metadata information comprises a reserved layer attribute, wherein the reserved layer attribute indicates that the detected at least one reserved patch layer comprises one or more updates to be integrated with the target data layer;
obtaining reserved layer content of the detected at least one reserved patch layer based on the determination that the obtained patch metadata information comprises the reserved layer attribute; and
integrating the obtained reserved layer content with the target data layer of the at least one target container image.

20. The computer program product of claim 19, wherein the program instructions stored on the one or more computer-readable storage media perform the operations further comprising:
receiving an assignment command for assigning the reserved layer attribute to the at least one reserved patch layer;
extracting a set of keywords from the received assignment command; and
storing the reserved layer attribute in the patch metadata information of the at least one reserved patch layer based on the extracted set of keywords.
